(19) United States
(12) Patent Application Publication
(10) Pub. No.: US 2021/0370583 A1
(43) Pub. Date: Dec. 2, 2021

(54) MULTIPLE LAYER FILAMENT AND METHOD OF MANUFACTURING

(71) Applicant: Essentium, Inc., Pflugerville, TX (US)

(72) Inventors: Blake Ryland Teipel, Pflugerville, TX (US); Charles Brandon Sweeney, Pflugerville, TX (US); Bryan Scott Zahner, Pflugerville, TX (US); Kevin Michael Holder, Houston, TX (US); Nirup Nagabandi, Pflugerville, TX (US); Ryan Vano, Pflugerville, TX (US); Elisa Marina Teipel, Pflugerville, TX (US); Alexander Stockton, Austin, TX (US)

(21) Appl. No.: 16/967,980

(22) PCT Filed: Feb. 8, 2019
(86) PCT No.: PCT/US2019/017235

§ 371 Date: Aug. 6, 2020

Related U.S. Application Data
(60) Provisional application No. 62/627,950, filed on Feb. 8, 2018.

(51) Int. Cl. B29C 64/118; B29C 64/205; B29C 64/321; B29C 64/393

(52) U.S. Cl. CPC B29C 64/118; B29C 64/393; B29C 64/321; B29C 64/205

(57) ABSTRACT

A system for manufacturing a multiple layer filament produces a multiple layer filament including a continuous core, a first layer and a second layer. The continuous core includes one of a continuous fiber, a braided strand, a metal wire and a narrow gauge filament. The materials for the first and second layers of the multiple layer filament are chosen from a plurality of materials with each of the plurality of materials providing a specific function or multiple functions that are required for the particular application of the three-dimensional object manufactured using the multiple layer filament.

### CROSS REFERENCE TO RELATED APPLICATION

This application claims the benefit of U.S. Provisional Patent Application Ser. No. 62/62,950, filed Feb. 8, 2018, which is hereby incorporated in its entirety herein by reference.

### FIELD

The present disclosure relates generally to a multiple layer filament for use in three dimentional printing and a method of manufacturing a multiple layer filament.

### BACKGROUND

The statements in this section merely provide background information related to the present disclosure and may or may not constitute prior art.

Three Dimensional Printing or Additive Manufacturing represents several processes for creating three dimensional objects from a digital CAD design model. A three dimensional printed part is formed by stacking several two dimensional layers of material such that the end result is an object having length, width, and height. In several of the processes, materials used to form the objects can range from metal to thermoplastic and composite. However, while these processes are capable of quickly producing intricate parts including great detail, the current processes seem capable of producing objects having only very limited purposes. Such purposes include prototype parts, novelty objects, demonstration parts or assemblies, or parts having other light duty purposes. This limited use is mainly due to the ability of the additive assembly processes to produce parts having high cohesive strength between several two dimensional layers of the printed part.

Some process improvements include attempts to increase the cohesive strength between the layers of the three dimensional printed object. These attempts include in-process and post-process steps that involve different methods of heating the printed object such that the layers soften or even melt to promote cross-solidification or crystallization between the layers. However, heating the entire three dimensional part either in-process or post-process may result in distortion of the part through sagging and lingering residual stresses, among other defects. Other improvements focus on filament structure and materials.

While current three dimensional printers and processes achieve their intended purpose, there is a need for an improved three dimensional printing process and filament materials for providing parts for an increasing array of applications requiring improved strength, dimensional capability, and multi-functional purposes.

### SUMMARY

A filament manufacturing system for making filament for use in three-dimensional printing is provided. The filament manufacturing system comprises a core spool and a first layer applicator apparatus. The core spool comprises a continuous core material. The first layer applicator apparatus comprises a first layer applicator and a plurality of first layer materials, and wherein the first layer applicator apparatus is disposed to receive the continuous core material from the core spool and dispose at least one of the plurality of first layer materials onto a first outer surface of the continuous core material to form a first multiple layer filament.

In one example of the present disclosure, the filament manufacturing system further comprises a second layer applicator apparatus comprising a second layer applicator and a plurality of second layer materials. The second layer applicator apparatus is disposed to receive the first multiple layer filament from the first layer applicator apparatus. The second layer applicator disposes at least one of the plurality of second layer materials onto a second outer surface of the first multiple layer filament to form a second multiple layer filament.

In another example of the present disclosure, the continuous core material is at least one of a fiber, a braided strand, and a narrow gauge filament.

In yet another example of the present disclosure, the continuous core material is at least one of a carbon fiber, a glass fiber, a Kevlar® fiber, an aramid fiber, a cellulose based natural fiber, a mineral fiber, a synthetic polymer fibers, and a silicon carbide fiber.

In yet another example of the present disclosure, the plurality of the first layer materials comprises at least one of polylactic acid, polyesters, polyamides, polycarbonates, polyarylether ketones, polyether imides, thermoplastic elastomers, polyarylethersulfones, acrylonitrile butadiene styrene, polyamide-imide, polyurethanes, polyolefins, copolymers, composites made of a single polymer or combinations of polymers, functional and non-functional fillers, and functional moieties including monomers and modified polymers.

In yet another example of the present disclosure, the functional and non-functional fillers comprises at least one of carbon fiber, glass fiber, Aramid fiber, cellulosic materials, nanotubes, two-dimensional fillers, carbon black, colorant, reactive agents, organic chemicals with active functional groups, and nanoparticles.

In yet another example of the present disclosure, the first layer applicator apparatus comprises at least one of a co-extruder, a laminator, a liquid depositor, a spray depositor, an ink jet printer, and a primer.

In yet another example of the present disclosure, the plurality of the second layer materials comprises at least one of polylactic acid, polyesters, polyamides, polycarbonates, polyarylether ketones, polyether imides, thermoplastic elastomers, polyarylethersulfones, acrylonitrile butadiene styrene, polyamide-imide, polyurethanes, polyolefins, copolymers, composites made of a single polymer or combinations of polymers, functional and non-functional fillers, and functional moieties including monomers and modified polymers.

A method of manufacturing a filament for use in three-dimensional printing is also disclosed. The method comprises providing a core spool comprising a continuous core material. The continuous core material comprises at least one of a fiber, a braided strand, and a narrow gauge filament. A second step provides a first layer applicator apparatus comprising a first layer applicator and a plurality of first layer materials. The first layer applicator apparatus comprises at least one of a co-extruder, a laminator, a liquid depositor, a spray depositor, an ink jet printer, and a primer and the plurality of the first layer materials and the second layer materials comprises at least one of a polylactic acid, a polyester, a polyimide, a polycarbonate, a polyarylether ketone, a polyether imide, a thermoplastic elastomer, a polyarylethersulfone, an acrylonitrile butadiene styrene, a polyimide-imide, a polyurethane, a polyolefin, a copolymer, a composite made of a single polymer or a combination of polymers, a functional and a non-functional filler, and a functional moieties including a monomer and a modified polymer. A third step disposes a first layer onto a first outer surface of the continuous core material to form a first multiple layer filament. A fourth step provides a second layer applicator apparatus comprising a second layer applicator and a plurality of second layer materials. The second layer applicator apparatus is disposed to receive the first multiple layer filament from the first layer applicator apparatus. A fifth step disposes a second layer material onto a second outer surface of the first multiple layer filament to form a second multiple layer filament. The plurality of the second layer materials comprises at least one of a polylactic acid, a polyester, a polyamide, a polycarbonate, a polyarylether ketone, a polyether imide, a thermoplastic elastomer, a polyarylethersulfone, an acrylonitrile butadiene styrene, a polyamide-imide, a polyurethane, a polyolefin, a copolymer, a composite made of a single polymer or a combination of polymers, a functional and a non-functional filler, and a functional moieties including a monomer and a modified polymer.

In one example of the present disclosure, providing a first layer applicator apparatus comprising a first layer applicator and a plurality of first layer materials further comprises providing the first layer applicator apparatus comprising at least one of a laminator and a spray depositor.

In another example of the present disclosure, providing a second layer applicator apparatus comprising a second layer applicator and a plurality of second layer materials further comprises providing a second layer applicator apparatus comprising at least one of an ink jet printer and a primer.

In yet another example of the present disclosure, providing a core spool comprising a continuous core material, and wherein the continuous core material comprises at least one of a fiber, a braided strand, and a narrow gauge filament further comprises providing a continuous core material comprising at least one of a carbon fiber and a cellulose based natural fiber.

A system for manufacturing a multiple layer filament is also provided that produces a multiple layer filament including a continuous core, a first layer and a second layer. The continuous core includes one of a continuous fiber, a braided strand, a metal wire and a narrow gauge filament. The materials for the first and second layers of the multiple layer filament are chosen from a plurality of materials with each of the plurality of materials providing a specific function or multiple functions that are required for the particular application of the three-dimensional object manufactured using the multiple layer filament.

This disclosure adds functionality to a line of existing and in-development thermoplastics and thermoplastic composites used in additive manufacturing. The multilayered filament will be used primarily for fused filament fabrication (FFF). This will allow filament with the desired property (or properties) incorporated into the layer(s) to be accessible in both consumer and industrial 3D printer markets.

Layers can be formulated to interact with FFF technologies such as FlashFuse to chemically bond the layers in the z-direction to improve z-strength. In this regard, the outer layer or one of the layers will comprise any of the materials specified above or interlinking organic chemicals containing functionalities like thiols, nitriles, amides, carbonyls, alcohols, or amines or a combination of more than one which can react or interact with other layers of the filament upon a stimulus in the form of thermal, electrical, electromagnetic (UV, IR, Vis), viscosity, pH or pressure to improve Z-direction or even overall bulk strength.

Down below, an example figure for the proposed filaments given with 3 layers, but the multi-layer filament can contain any number of layers. Also, in the figure example composition of each layer is given for two different cases, but as mentioned earlier, each layer can have any composition. To be precise, any given layer could be a consisting of a polymer, composite polymer, fiber, continuous fiber, functional moiety, fiber composite, organic functional chemicals.

The existing filament technology in the 3D printing market is primarily neat thermoplastics. To improve mechanical properties, some filaments have been produced using filler particles throughout the bulk of the material. The addition of fillers into a thermoplastic can have drastic effects on the filament printability and finished part performance. The significance of this disclosure is that, first and most importantly, it allows many of the claimed functional properties to be added to 3D printing filament for the first time. This is significant when compared to introducing the functionality throughout the bulk of the filament because in the latter, there is risk of affecting mechanical, thermal and chemical properties, as well as the effective and successful printing of parts (examples include: tensile strength, tensile modulus, impact resistance, heat deflection temperature, etc.). By adding the functionality through a multilayer system where the layers comprise only a fraction of total filament thickness, any negative impact on physical and chemical properties of the base material is minimized, while also reducing material consumption and cost of the functional additive. The present disclosure can be used by industrial and consumer 3D printing processes and can enhance the manufacturing of parts. Such parts may pertain to the aerospace, automotive, defense, space, electronics, biomedical, and marine industries. Multilayer filament offers a large range of new properties, some of which will potentially allow them to exist in environments that were previously impossible for thermoplastic printed parts to function. Parts will additionally become better suited for end use applications, broadening potential use beyond prototyping and similar.

In addition to adding functionality with layers without inhibiting the primary material properties, the layer can be formulated in such a way that will facilitate modification of the base material (such as adding high fiber content). Modifying the base material without additional layer(s) could lead to a filament that is no longer printable via FFF due to increased stiffness or reduced melt flow. Added layers can compensate for the adverse effects on printability of high performance composite materials. A multilayer system could allow for the introduction of very high-performance materials into the FFF 3D printing market using composite layer materials. Additionally, stimulus responsive layers can be added to adjust the material performance while printing, or after a part is printed, allowing printability to be maintained and still achieving enhanced material performance and functionality.

Previous technologies including neat thermoplastic filament and thermoplastic composite filament have yet to offer applicable functionality in 3D printed parts. Previous technology incorporating a coating onto 3D printing filament does cover microwave-active coatings that allow for surface welding of 3D printed parts to make them equal to injected molded parts with regards to mechanical properties. The current disclosure allows for selective incorporation of desired functionality to FFF 3D printed parts by offering the functionalities mentioned above and any combinations thereof. The multilayer formulations discussed here are a completely new offering that will greatly expand the capabilities of additive manufacturing in the form of FFF. For the first time, layers tailored for each final multilayer filament will add the claimed functionalities to 3D printed parts. Each functionality requires materials knowledge to account for varying physical and chemical properties (i.e., while the disclosure is the same, each functional property requires fine tuning and varying additive chemistries that must be accounted for to secure stability between layers). One example of such novelty is the incorporation of a moisture vapor barrier mantel layer to reduce moisture uptake of the multilayer filament. This will limit product loss due to embrittlement from hydrolysis degradation as well as limit the need for drying prior to printing to prevent the evaporating moisture from causing bubbles and failure of printed parts. There are currently no viable options in the 3D printing filament literature or IP space that address the issue of moisture uptake in filament. Oxidation and/or UV degradation protected filament are also novel FFF filaments that will improve filament and final part shelf life by adding protection from environmental factors such as light and oxygen. Such layers will incorporate scavengers and/or barriers to oxygen or UV radiation.

Other examples and advantages of the disclosure will be explained in further detail by reference to the following description and appended drawings.

### DRAWINGS

The drawings described herein are for illustration purposes only and are not intended to limit the scope of the present disclosure in any way.

FIG. 1 is a schematic depiction of a manufacturing process for producing a multiple layer filament according to the principles of the present disclosure; and

FIG. 2 illustrates a multiple layer filament according to the principles of the present disclosure.

### DETAILED DESCRIPTION

The following description is merely exemplary in nature and is not intended to limit the present disclosure, application, or uses,

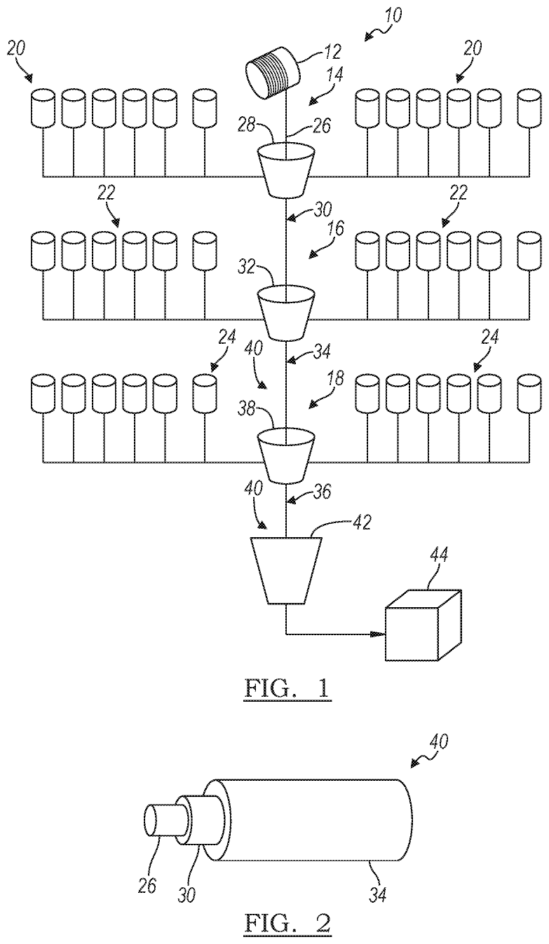

Referring to FIG. 1, a schematic of a multiple layer filament system for manufacturing and a method of manufacturing a multiple layer filament is illustrated and will now be described. A multiple layer filament system 10 includes a core spool 12, a first layer applicator apparatus 14, a second layer applicator apparatus 16, a third layer applicator apparatus 18, and several pluralities of layer materials 20, 22, 24. More specifically, the core spool 12 includes a continuous core 26 that is fed from the core spool 12 into the first layer applicator 14. The core 26 includes material that may be in one of many forms including but not limited to a continuous fiber, a braided strand, a metal wire or a narrow gauge filament. For example, the continuous fiber and braided strand may be formed from a carbon fiber, a glass fiber, a Kevlar® fiber, an aramid fiber, cellulose based natural fiber, mineral fiber, synthetic polymer fibers, or silicon carbide fiber.

The first layer applicator apparatus 14 includes a first of the plurality of layer materials 20 and a first layer applicator 28. The first of the plurality of layer materials 20 includes a number of materials that each provides a specific function or series of functions for a first layer 30 that is disposed on the surface of the core 26. For example, the plurality of layer materials 20 includes materials that provide functions including radiation absorption, UV protection, oxidation protection, hydrophobicity, antimicrobial, mechanical strength, electric conductivity, anti-static, dielectric, ferro-magnetic, thermal conductivity, electrically insulating, bio-friendly, chemical resistance, reduced friction, corrosion resistance, moisture, oxygen, or CO₂ barrier, flame retardant, thermal insulation, mechanophore or mechanichromic, interlayer adhesion promotion, chemically active, UV crosslinking responsive, buffer layer, stacked layers, bi-component polymer multiple layer filament, catalytic behavior, abrasion resistance, self-lubrication, photoluminescent, photochromic, hydrophilicity, oleophobic, and oleophilic.

The plurality of layer materials 20 that provide the functional layers given above include polylactic acid (PLA), polyesters (PET, PETG, PCTG, PBT), polyamides (PA), polycarbonates (PC), polyarylether ketones (PEK, PEEK, PEAK, PEKK, PEEKK), polyether imides(PEI), Thermoplastic elastomers (TPS, TPO, TPV, TPU, TPC, TPA, TPZ), polyarylethersulfones (PSU, PES, PAS, PESU, PPSU), acrylonitrile butadiene styrene (ABS), polyamide-imide (PAI, Torlon), polyurethanes, polyolefins, copolymers, composites made of a single polymer or combinations of polymers, functional and non-functional fillers, and functional moieties including monomers and modified polymers, and any combinations of these materials.

As stated above, composites may include functional and non-functional fillers. The fillers included may be chosen from the group of carbon fiber (chopped, short, long), glass fiber (short, long), Aramid fiber (short, long), cellulosic materials (fibrils, crystals, nanoparticles, micro crystalline cellulose), nanotubes (carbon, boron nitride, titanic, silicates, halloysite), two-dimensional fillers (graphene, boron nitride sheets, natural silicates such as clay or mica), carbon black, colorant, reactive agents (Ultraviolet activated, cross-linkers, O₂ scavengers), organic chemicals with active functional groups (thiols, carbonyls, amines, nitriles, alcohols, anhydrides), and nanoparticles (diamond, metal, carbon-based, two-dimensional materials).

The first lay applicator apparatus 14 deposits the first layer material in one of a number of processes. The processes of layer deposition may include co-extrusion, lamination, deposition from liquid, spray depositing, and ink jet printing. A primer step may also be included in the deposition process. For example, co-extrusion allows for the extrusion of multiple layers in a single 3D printing filament during an extrusion process. The inner layer could be filled or unfilled material. Additional layers could comprise of some type of functional formulation made up in part of the same or similar base polymer or at least a compatible polymer resin. These two (or more) layers would be extruded together using a co-extrusion process.

Layers may also be applied through a lamination process. This would involve adding the desired properties to a thin film of the material, then laminating onto the 3D filament in a line process, or onto the filament post production during a re-winding event.

Deposition from liquid requires the core 26 or multiple layer filament to be drawn through one or more bath cycles for the deposition of a thin layer. The bath may contain a mixture of the functional component such as acid, base, water-soluble polymer, and a solvent.

Spray depositing can apply a layer, or layers, via dilute suspensions of material onto the filament shortly after extrusion in a single process, or in a separate step.

Another process includes inkjet printing layers via liquid dispersions after filament production.

The primer step may be necessary when layers may require an initial surface priming step to prepare the surface to accept additional layer(s). Possible priming steps could include deposition of an active species (charged, electromagnetic wave active, photo-active, heat active, etc.), or a charge inducing pass through a plasma treatment. Multiple co-extrusion passes could also solve compatibility issues by adding a primer layer that acts as a compatibilizer between the layers.

The second layer applicator apparatus 16 includes a second of the plurality of layer materials 22 and a second layer applicator 32. The second of the plurality of layer materials 22 may include the same materials as stated above as included in the first of the plurality of layer materials 20. The second layer applicator 32 deposits a second layer 34 on the surface of the first layer 30. Again, each of the second of the plurality of layer materials 22 performs a specific function as it pertains to the material or combination of materials used for the second layer 34.

In some embodiments, the third layer applicator apparatus 18 may be employed to deposit a third layer 36 on the surface of the second layer 34. The third layer applicator apparatus 18 includes a third of the plurality of layer materials 24 and a third layer applicator 38. The third of the plurality of layer materials 24 may include the same materials as stated above as included in the first and second of the plurality of layer materials 20, 22. Again, each of the third of the plurality of layer materials 24 performs a specific function as it pertains to the material or combination of materials used for the third layer 38.

The multiple layer filament system 10 can be used to manufacture a multiple layer filament 40 for storage and use at a later time or it can be fed directly to a three dimensional printer 42 for manufacturing a rapidly produced three dimensional object 44. In either application, the multiple layer filament system 10 produces a project specific multiple layer filament 40 that has tailored functional layers 26, 30, 34.

Turning now to FIG. 2 with continuing reference to FIG. 1, the multiple layer filament 40 is illustrated and will now be described. The multiple layer filament 40 includes the continuous core 26, the first layer 30, and the second layer 34. As described above, the continuous core 26 may be one of a continuous fiber, a braided strand, a metal wire or a narrow gauge filament. For example, the continuous fiber and braided strand may be formed from carbon fiber, glass fiber, Kevlar® fiber, aramid fiber, cellulose based natural fiber, mineral fiber, synthetic polymer fibers, or silicon carbide fiber.

The first and second layers 30, 34 may each be made from one or a combination of materials. The selection of materials is largely based on the desired function of that particular layer 30, 34 of the multiple layer filament. As stated above, the desired function may include radiation absorption, UV protection, oxidation protection, hydrophobicity, antimicrobial, mechanical strength, electric conductivity, anti-static, dielectric, ferro-magnetic, thermal conductivity, electrically insulating, bio-friendly, chemical resistance, reduced friction, corrosion resistance, moisture, oxygen, or CO₂ barrier, flame retardant, thermal insulation, mechanophore or mechanichromic, interlayer adhesion promotion, chemically active, UV crosslinking responsive, buffer layer, stacked layers, bi-component polymer multiple layer filament, catalytic behavior, abrasion resistance, self-lubrication, photoluminescent, photochromic, hydrophilicity, oleophobic, and oleophilic. The desired function may be the desired function of the particular layer of the multiple layer filament 40 or it may be one of the desired function of the three-dimensional object 44 that is manufactured using the multiple layer filament 40.

The first and second layers 30, 34 may be made from polylactic acid (PLA), polyesters (PET, PETG, PCTG, PBT), polyamides (PA), polycarbonates (PC), polyarylether ketones (PEK, PEEK, PEAK, PEKK, PEEKK), polyether imides(PEI), Thermoplastic elastomers (TPS, TPO, TPI, TPU, TPC, TPA, TPZ), polyarylethersulfones (PSU, PES, PAS, PESU, PPSU), acrylonitrile butadiene styrene (ABS), polyamide-imide (PAI, Torlon), polyurethanes, polyolefins, copolymers, composites made of a single polymer or combinations of polymers, functional and non-functional fillers, and functional moieties including monomers and modified polymers, and any combinations of these materials.

The first and second layers 30, 34 may also include one of a continuous fiber, a braided strand, a metal wire or a narrow gauge filament.

As stated above, composites may include functional and non-functional fillers. The fillers included may be chosen from the group of carbon fiber (chopped, short, long), glass fiber (short, long), Aramid fiber (short, long), cellulosic materials (fibrils, crystals, nanoparticles, micro crystalline cellulose), nanotubes (carbon, boron nitride, titanic, silicates, halloysite), two-dimensional fillers (graphene, boron nitride sheets, natural silicates such as clay or mica), carbon black, colorant, reactive agents (Ultraviolet activated, cross-linkers, O₂ scavengers), organic chemicals with active functional groups (thiols, carbonyls, amines, nitriles, alcohols, anhydrides), and nanoparticles (diamond, metal, carbon-based, two-dimensional materials).

The description of the disclosure is merely exemplary in nature and variations that do not depart from the gist of the disclosure are intended to be within the scope of the disclosure. Such variations are not to be regarded as a departure from the spirit and scope of the disclosure.

1-20. (canceled)

21. A multiple layer filament comprising:
a core material having an outer surface, wherein the core material includes at least one of a thermoplastic filament, a continuous fiber, a braided strand, and a metal wire; and
a first layer material disposed on the outer surface of the core material,
wherein the first layer provides at least one functionality to the multiple layer filament.

22. The multiple layer filament of claim 21, wherein first layer material disposed on the outer surface of the core material improves printability of the multiple layer filament as compared to the printability of the core material without the first layer.

23. The multiple layer filament of claim 21, wherein the core material includes at least one of a chopped carbon fiber, glass fiber, aramid fiber, cellulosic fibrils, cellulosic crystals, cellulosic nanoparticles, cellulosic microparticles, micro crystalline cellulose, carbon nanotubes, boron nitride nanotubes, titania nanotubes, silicane nanotubes, halloysite nanotubes, graphene, boron, nitride sheets, natural silicates, carbon black, colorants, ultra violet reactive agents, crosslinkers, oxygen scavengers, active functional groups including thiols, carbonyls, amines, nitriles, alcohols, anhydrides, diamond nanoparticles, metal nanoparticles, carbon based nanoparticles, graphene nanoparticles, boron nanoparticles, nitride sheet nanoparticles, and natural silicate nanoparticles.

24. The multiple layer filament of claim 21, wherein the first layer material comprises at least one of polylactic acid, polyester, polyamide, polycarbonate, polyarylether ketone, polyether imide, thermoplastic elastomer, polyarylethersulfone, acrylonitrile butadiene styrene, polyamide-imide, polyurethane, and polyolefin.

25. The multiple layer filament of claim 21, wherein the first layer is a moisture vapor barrier layer.

26. The multiple layer filament of claim 21, wherein the first layer incorporates at least one of a scavenger, an oxygen barrier, and a UV radiation barrier.

27. The multiple layer filament of claim 21, wherein the first layer provides at least one of the following functionalities to the multiple layer filament: antimicrobial, mechanical strength, electric conductivity, anti-static, dielectric, ferro-magnetic, thermal conductivity, electrically insulating, bio-friendly, chemical resistance, reduced friction, corrosion resistance, CO2 barrier, flame retardant, thermal insulation, mechanophore or mechanochromic, interlayer adhesion promotion, chemically active, UV crosslinking responsive, buffer layer, stacked layers, bi-component polymer multiple layer filament, catalytic behavior, abrasion resistance, self-lubrication, photoluminescent, photochromic, hydrophilicity, oleophobic, and oleophilic properties.

28. The multiple layer filament of claim 21, wherein the first layer includes at least one of a chopped carbon fiber, glass fiber, aramid fiber, cellulosic fibrils, cellulosic crystals, cellulosic nanoparticles, cellulosic microparticles, micro crystalline cellulose, carbon nanotubes, boron nitride nanotubes, titania nanotubes, silicane nanotubes, halloysite nanotubes, graphene, boron, nitride sheets, natural silicates, carbon black, colorants, ultra violet reactive agents, crosslinkers, oxygen scavengers, active functional groups including thiols, carbonyls, amines, nitriles, alcohols, anhydrides, diamond nanoparticles, metal nanoparticles, carbon based nanoparticles, graphene nanoparticles, boron nanoparticles, nitride sheet nanoparticles, and natural silicate nanoparticles.

29. The multiple layer filament of claim 21, further comprising a second layer, wherein the second layer provides at least one of the following functionalities to the multiple layer filament: antimicrobial, mechanical strength, electric conductivity, anti-static, dielectric, ferro-magnetic, thermal conductivity, electrically insulating, bio-friendly, chemical resistance, reduced friction, corrosion resistance, CO2 barrier, flame retardant, thermal insulation, mechanophore or mechanochromic, interlayer adhesion promotion, chemically active, UV crosslinking responsive, buffer layer, stacked layers, bi-component polymer multiple layer filament, catalytic behavior, abrasion resistance, self-lubrication, photoluminescent, photochromic, hydrophilicity, oleophobic, and oleophilic properties.

30. The multiple layer filament of claim 21, further comprising a second layer material, wherein the second layer material comprises at least one of polylactic acid, polyester, polyamide, polycarbonate, polyarylether ketone, polyether imide, thermoplastic elastomer, polyarylethersulfone, acrylonitrile butadiene styrene, polyamide-imide, polyurethane, polyolefin, copolymer, composites of a single polymer and composites of a combination of polymers.

31. The multiple layer filament of claim 30, wherein the second layer includes at least one of a chopped carbon fiber, glass fiber, aramid fiber, cellulosic fibrils, cellulosic crystals, cellulosic nanoparticles, cellulosic microparticles, micro crystalline cellulose, carbon nanotubes, boron nitride nanotubes, titania nanotubes, silicane nanotubes, halloysite nanotubes, graphene, boron, nitride sheets, natural silicates, carbon black, colorants, ultra violet reactive agents, crosslinkers, oxygen scavengers, active functional groups including thiols, carbonyls, amines, nitriles, alcohols, anhydrides, diamond nanoparticles, metal nanoparticles, carbon based nanoparticles, graphene nanoparticles, boron nanoparticles, nitride sheet nanoparticles, and natural silicate nanoparticles.

32. The multiple layer filament of claim 30, wherein the second layer is a moisture vapor barrier layer.

33. The multiple layer filament of claim 30, wherein the second layer is an oxidation, UV, or oxidation and UV barrier layer.

34. The multiple layer filament of claim 30, further comprising a primer layer between the first layer and the second layer, wherein the primer includes an active species that is one of charged, activated by electromagnetic waves, photo-active or heat active.

35. The multiple layer filament of claim 30, further comprising a primer layer that provides a compatibilizer between the first and second layers.

36. A manufacturing system for making a multiple layer filament for use in three-dimensional printing, the manufacturing system comprising:
a core spool comprising a core material, wherein the core material includes at least one of a thermoplastic filament, a continuous fiber, a braided strand, and a metal wire; and
a first layer applicator apparatus comprising a first layer applicator and a first layer material, wherein the first layer material provides at least one functionality to the multiple layer material and wherein the first layer applicator apparatus is disposed to receive the core material from the core spool and dispose the first layer material onto a first outer surface of the core material to form the multiple layer filament.

37. The manufacturing system of claim 36, wherein the first layer applicator apparatus comprises at least one of a co-extruder, a laminator, a liquid depositor, a spray depositor, an ink jet printer, and a primer.

38. The manufacturing system of claim 36, wherein the first layer applicator apparatus comprises a co-extruder and the second layer applicator apparatus comprises a liquid depositor.

39. A method of manufacturing a multiple layer filament for use in three-dimensional printing, the method comprising:
providing a core spool comprising a core material, wherein the core material includes at least one of a thermoplastic filament, a continuous fiber, a braided strand, and a metal wire;
providing a first layer applicator apparatus comprising a first layer applicator and a first layer material, wherein the first layer material provides at least one functionality to the core material and wherein the first layer applicator apparatus comprises at least one of a co-extruder, a laminator, a liquid depositor, a spray depositor, an ink jet printer; and
disposing a first layer onto a first outer surface of the core material to form the multiple layer filament with the first layer applicator apparatus.

40. The method of manufacturing of claim 39 wherein providing a first layer applicator apparatus comprising a first layer applicator and a first layer material further comprises providing the first layer applicator apparatus comprising at least one of a laminator and a spray depositor.
